(19) United States
(12) Patent Application Publication
(10) Pub. No.: US 2026/0359884 A1
(43) Pub. Date: Nov. 12, 2026

(54) VIRTUAL ENVIRONMENT FOR DIGITAL PLATFORM UNIFICATION

(71) Applicant: FyleMyStyle LLC, Miami, FL (US)

(72) Inventor: Elizabeth JACKSON, Miami, FL (US)

(73) Assignee: FyleMyStyle LLC, Miami, FL (US)

(21) Appl. No.: 19/366,236

(22) Filed: Oct. 22, 2025

Related U.S. Application Data
(60) Provisional application No. 63/859,663, filed on Aug. 7, 2025.
(60) Provisional application No. 63/801,300, filed on May 7, 2025.

(51) Int. Cl. G06Q 30/0601; G06N 20/00; G06T 17/00

(52) U.S. Cl. CPC G06Q 30/06442; G06N 20/00; G06Q 30/06311; G06Q 30/0633; G06T 17/00

(57) ABSTRACT

Embodiments provide for improved digital integration are provided. A user profile of a user of an interactive platform is accessed, and a personalized artificial intelligence (AI) assistant is generated based on the user profile. A plurality of category recommendations is generated, for a plurality of categories, based on the user profile and using the personalized AI assistant. A plurality of virtual rooms is generated for the plurality of category recommendations, where each respective virtual room of the plurality of virtual rooms corresponds to a respective category of the plurality of categories and comprises a respective set of category recommendations from the plurality of category recommendations. A set of category recommendations, of the plurality of category recommendations, is output for the user in a first virtual room of the plurality of virtual rooms.

### CROSS-REFERENCE TO RELATED APPLICATIONS

This Application claims the benefit of and priority to U.S. Provisional Patent Application No. 63/801,300, filed on May 7, 2025, and U.S. Provisional Patent Application No. 63/859,663, filed Aug. 7, 2025, the entire contents of each of which are incorporated herein by reference.

### BACKGROUND

The rise of online digital platforms has increasingly changed the way users share information among each other, as well as how users interact with tangible and intangible things in both the real and the virtual worlds. While such online approaches can increase convenience and access to data, the proliferation of a myriad of digital platforms has significantly increased access complexity and complicated data handling. For example, while a given digital platform may provide easy access to and control of information associated with the given platform, there are generally no cross-links between such platforms. That is, data and information managed by one platform is generally inaccessible to users of other platforms, and users who utilize multiple discrete platforms must manage these environments separately.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example system for unifying digital platforms, according to some embodiments of the present disclosure.

FIGS. 2A and 2B depict example profile virtual rooms for unifying digital platforms, according to some embodiments of the present disclosure.

FIGS. 3A, 3B, and 3C depict example virtual rooms for category-specific platform unification, according to some embodiments of the present disclosure.

FIG. 4 is a flow diagram depicting an example method for generating personalized models for information management, according to some embodiments of the present disclosure.

FIG. 5 is a flow diagram depicting an example method for generating and rendering customized virtual rooms, according to some embodiments of the present disclosure.

FIG. 6 is a flow diagram depicting an example method for efficient information sharing, according to some embodiments of the present disclosure.

FIG. 7 is a flow diagram depicting an example method for generating category recommendations, according to some embodiments of the present disclosure.

FIG. 8 depicts an example computing device configured to perform various embodiments of the present disclosure.

FIG. 9 depicts an example system for managing and categorizing user-generated inventory lists across multiple digital platforms, according to some embodiments of the present disclosure.

FIG. 10 is a flow diagram depicting an example method for managing and categorizing user-generated inventory lists across multiple digital platforms, according to some embodiments of the present disclosure.

### DETAILED DESCRIPTION

Embodiments of the present disclosure provide techniques for improved digital interaction, and more specifically, improved integration of information in a unified virtual platform.

In some embodiments, an integrated digital platform is provided to unify information, knowledge, and experiences from a variety of different categories and platforms to improve data management and access. In some aspects, techniques and workflows are provided to integrate information related to products, experiences, services, and the like. For example, information from different digital shopping platforms may be aggregated and repackaged to improve accessibility and interactions among users.

In some embodiments, users may train and use customized artificial intelligence (AI) assistants or agents to provide item recommendations and facilitate information sharing. For example, in addition to recommending items (e.g., based on the user’s preferences and budget), the customized assistant may further offer information about the item that is relevant or useful to the user (e.g., noting that the item uses the same ingredients as another item the user likes, indicating that the item has better reviews than other items the user usually prefers, and the like).

In some aspects, the integrated platform can organize items and information based on defined categories (e.g., a category for food and beverage, a category for vacation options, a category for clothing, and the like). In some embodiments, the platform generates virtual rooms for each category, where the corresponding items can be accessed or evaluated. For example, the user may interact with the platform to enter a virtual room related to shoes, where the user’s personalized AI assistant may present or provide information about recommended shoes from a myriad of different digital platforms.

In some embodiments, the virtual rooms are visually represented using images, video, or other media depicting a physical space with the relevant items arranged in the space (e.g., as a wine cellar with wine suggestions along the walls). In some embodiments, the virtual rooms are three-dimensional scenes through which the user can move and interact. In some embodiments, the user may use virtual reality device(s) to interact with the virtual rooms (e.g., to move through the virtual space, select and interact with objects, interact with their AI assistant, and the like).

In some embodiments, each category may have an associated authority user (e.g., a subject matter expert). In some embodiments, the authority user in a given category is an individual who is generally known to have relevant expertise in the field. As one example, a professional golfer may be the authority figure for the “golf” category, a chef from a successful restaurant may be the authority for a “cooking” category, and the like.

In some embodiments, the authority may curate item recommendations, provide input or information about various objects, and the like. As one example, the user may ask about a particular object, and the authority figure may respond by providing context or details about the object. In some embodiments, the authority is represented using a corresponding AI assistant trained by and/or for the subject matter expert (e.g., a Chatbot) to provide information about the category. In some embodiments, the authority may be represented as an avatar in the corresponding virtual room. For example, when the user enters a virtual room, the corresponding authority avatar may greet the user, offer suggestions, and the like.

In some embodiments, these virtual rooms are customized and tailored to the individual user. For example, recommended items may be generated for the user (e.g., using the user’s personalized AI), and a virtual room fitting the user’s preferences (e.g., with an ambience or visual effect that aligns with the user’s inclinations) may be generated, where the virtual room includes the user-specific recommendations in addition to the authority recommendations or information (which may be shared across users). In some embodiments, in addition to customizing the appearance and structure of the virtual room itself, the platform may further customize the appearance, sound, personality, or other aspects of the user’s AI assistant based on the category or room.

For example, in a “wine” virtual room, the user’s AI assistant may use an avatar related to wine, such as taking on the appearance of a sommelier (e.g., changing clothes, hairstyle, or other aspects of the avatar). In a “sporting goods” room, the AI assistant’s avatar may similarly wear sport-related clothing (e.g., jerseys or exercise clothing). In some embodiments, the AI assistant may be further customized based on the particular objects or items in the virtual room. For example, if the user asks about a particular wine in the “wine” room, the AI assistant may determine the country of origin for the bottle, and use a corresponding accent (e.g., using a French accent to respond to questions about French-made wines) or otherwise customize the avatar’s appearance, personality, voice, or other details based on the particular context of the item.

In some embodiments, in addition to category-specific virtual rooms, the user may also have a personalized profile room containing information related to the user, such as items the user has selected or curated (e.g., items the user previously purchased or desires to purchase), reviews or posts made by the user, and the like. In some embodiments, the user may share some or all of their personal room with others (e.g., via shareable links, such as using a quick response (QR) code). By following such links, other users can see the curated items selected by each other, interact with a virtual avatar representing the user in the personalized room, and the like. In some aspects, if a user decides to select (e.g., purchase) an item included in another user’s personal room, the other user may receive a reward, such as a commission, based on the selection. For example, if a friend visits a user’s personal room and selects a jacket recommended by the user, the user may be rewarded with a monetary compensation (e.g., as a percentage of the price of the jacket). In some embodiments, the reward system may include a leaderboard system. For example, a category-specific leaderboard system may be used where points can be awarded based on how influential each user is (e.g., how many times other users select or approve of the given user’s item suggestions).

In some embodiments, as discussed above, the information contained within any given virtual room may be sourced from a wide variety of other digital platforms. By unifying these disparate platforms, the interactive systems described herein can significantly reduce data access complexities and improve the efficiency of navigating these spaces. In some embodiments, the information from various other platforms can be repackaged or transformed to present a unified and cohesive appearance and structure in the virtual room. For example, rather than simply copying and sharing the information (e.g., images of the item), the interactive system may generate a new virtual object (e.g., a three-dimensional model) to represent the item, ensuring that the virtual objects in the room are compatible and cohesive (e.g., having the same look and feel). This not only improves the seamless nature of the platform, but also ensures accurate comparisons and evaluations can be made within the space. As another example, rather than copying written descriptions for various items directly, the AI assistant may be used to rephrase or summarize the information in a unified manner, improving information accessibility and enabling one-to-one comparisons. In some embodiments, when a user decides to select or pursue a given item or service (e.g., to book a vacation or purchase an item), the interactive platform may dynamically provide a link to the requested object (e.g., a link to the digital platform providing the item), allowing the user to quickly complete the transaction without interruption or difficulty.

In some embodiments, the described systems can include or provide global and/or multilingual scalability. For example, various aspects can implement localization based on the particular region(s) or locale(s) where the user is located, such as multiple currency support (e.g., changing currency based on the locale), multi-language support (e.g., changing language automatically, or providing a suggestion to change language, based on the location), and the like. In some embodiments, the systems can include evaluation of regional trends when interacting with users (e.g., evaluating regional purchasing trends when suggesting items to the users, such that suggestions reflect these local trends).

In some embodiments, an integrated platform designed to enhance user engagement through education, promotional activities, and commission-based compensation across various retail experience environments is provided. In some aspects, the platform involves creating a unified space for consumer experiences, brand optimization, promotional bidding, and revenue generation, while enabling users to create, customize, and share inventory lists. The platform leverages machine learning algorithms to provide personalized recommendations and compiles purchases from multiple online stores into a single, organized list for easy tracking.

In today’s retail experience landscape, consumers face significant challenges accessing consolidated information about products, stores, and shopping experiences across disparate digital platforms. While shoppers increasingly rely on wishlists and inventory lists to track desired items, these tools remain siloed within individual retailer ecosystems, forcing consumers to navigate multiple unconnected systems. Compounding this fragmentation, brands lack effective channels to educate consumers about their complete product offerings across retail experience partners, resulting in missed opportunities for product discovery and brand loyalty. The current environment fails to provide a unified interface where consumers can simultaneously manage their shopping interests while receiving comprehensive brand education and store-specific availability information.

Existing promotional frameworks further exacerbate these limitations through disconnected, non-competitive structures. During critical shopping periods like holiday sales or product launches, the absence of cohesive bidding mechanisms prevents retailers from dynamically competing for consumer attention through optimized promotional strategies. This deficiency in coordinated promotion technology leads to suboptimal pricing visibility for consumers and inefficient customer acquisition for brands. Moreover, the modern retail experiences ecosystem overlooks valuable opportunities to incentivize consumer participation, as current systems fail to properly leverage commission-based models that could reward users for product advocacy, social sharing, or community engagement.

Though some attempts at partial solutions have been provided, there remains substantial technological gap demonstrating a clear need for an integrated platform that bridges a variety of functionalities. A system capable of harmonizing consumer inventory management with brand education tools, competitive promotional frameworks, and commission-based engagement models is desired. This solution should maintain robust technical performance while delivering the unified experience consumers demand and the go-to-market capabilities brands require—all within a secure, scalable architecture that respects user privacy and data integrity. The present disclosure provides a comprehensive digital commerce platform that revolutionizes the consumer shopping experience by creating a unified hub for product discovery, evaluation, and engagement. This centralized system enables consumers to organize and track desired products across multiple retailers and actively participate in a vibrant shopping community by sharing detailed reviews, ratings, and experiential feedback about specific products, brands, and retail experiences. The platform transforms passive wishlisting into an interactive ecosystem where shoppers can research products through authentic peer perspectives while contributing their own insights. For brands and retailers, the system offers powerful tools to increase product visibility and consumer education across all partnered stores, with specialized interfaces to showcase product features, usage scenarios, and availability information in a standardized format that appears alongside user-generated content. This dual-stream architecture creates a rich information environment where professional brand messaging and organic consumer opinions coexist to drive more informed purchasing decisions.

In some embodiments, the integrated marketplace dynamics engine can coordinate promotional bidding systems, commission-based engagement models, and competitive analytics. The promotional bidding feature allows retailers to compete for consumer attention during key shopping periods by submitting time-limited offers for products appearing in user collections, creating a dynamic marketplace that benefits shoppers and sellers. The system’s sophisticated compensation infrastructure enables consumers to earn commissions through various forms of participation, including social sharing of product lists, creating influential reviews, and driving actual purchases through their network. Advanced tracking mechanisms monitor engagement metrics across all platform activities, providing valuable insights into consumer behavior while ensuring proper attribution for commission calculations. These interconnected features foster a thriving retail experience ecosystem where consumers are rewarded for participating, brands gain valuable exposure and sales opportunities, and retailers benefit from competitive intelligence and performance data - all facilitated through a seamless platform interface.

Some embodiments of the present disclosure are directed to a system and method for managing and categorizing user-generated inventory lists across multiple digital platforms to achieve a variety of features, advantages, and objects. These embodiments address the challenges associated with fragmented wishlists, lack of personalized recommendations, and the inability to compile purchases from multiple online stores into a single, organized list. Some embodiments provide a comprehensive framework that allows users to create, customize, and share inventory lists while leveraging machine learning algorithms to enhance the shopping experience.

As used herein, the term “User-Generated Inventory Lists” may refer to lists created by users to track items of interest across multiple digital platforms. These lists are categorized based on user preferences and can include items from various online stores. Similarly, the term “Machine Learning Algorithms” may refer to computational models trained on user activity, preferences, and historical data to generate personalized recommendations. These algorithms analyze patterns in user behaviour to suggest items that align with the user’s interests.

As used herein, the term “Personalized Recommendations” may refer to suggestions generated by the machine learning algorithms based on user activity, preferences, and historical data. These recommendations are tailored to the user’s interests and shopping habits. Additionally, the term “Shareable Link/QR Code” may refer to a unique link or code generated by the system that allows users to share their inventory lists or selected items with others. The link or code is associated with the user’s profile and provides access to the shared content.

Further, as used herein, the term “Sales Incentives” may refer to discounts, reward points, and gifting options provided to users based on their activity and purchases. These incentives are designed to enhance the user experience and encourage engagement with the platform. additionally, the term “Brand Interaction” may refer to the ability of brands associated with items on the user’s inventory list to send marketing ideas or promotional offers. It also includes competitors' ability to share their products' pros and cons with the user.

Moreover, as used herein, the term “Secure Sockets Layer (SSL) Encryption” may refer to a cryptographic protocol used to encrypt the connection between the server and remote user devices. SSL ensures that data transmitted between these components is protected from interception or tampering, maintaining the integrity and confidentiality of the communication.

As used herein, the term “Customizable Appearance” may refer to the ability of users to customize the appearance of their inventory lists to resemble a closet, wine cellar, shopping list, locker, or bookcase. This feature enhances the user experience by providing a visually appealing and personalized interface.

The described embodiments address a variety of technical problems, including the technical problem of managing and organizing user-generated inventory lists across multiple digital platforms while simultaneously creating an integrated ecosystem for consumer engagement and brand optimization. Conventional solutions, such as standalone Wishlist applications or platform-specific tools, fail to provide the comprehensive functionality required for modern retail experience environments. These limited systems cannot support the complex interactions between consumers, brands, and retailers that the present disclosure enables through its innovative architecture. The platform’s technical implementation solves these deficiencies by combining advanced inventory management with community features, brand education tools, and commercial partnership systems in a unified framework.

In some embodiments, a multi-layered platform architecture is provided that facilitates a rich consumer experience, sharing alongside traditional shopping functions. The system provides specialized user interfaces to contribute detailed product evaluations, retailer assessments, and shopping experience narratives. These community-generated insights are stored in association with relevant products and stores within the platform’s database, creating a knowledge base that enhances purchasing decisions. The technical implementation includes sophisticated content moderation algorithms and reputation scoring systems to maintain information quality while encouraging participation. Each listed product features dedicated sections for consumer feedback that are dynamically updated and presented through the user interface based on relevance scoring and user preferences.

In some embodiments, the platform’s brand education capabilities represent a significant technical advancement over conventional systems. Brands gain access to specialized dashboard interfaces that allow them to create and manage comprehensive product information packages. These packages include detailed specifications, usage scenarios, comparison guides, and retail experiences availability data automatically synchronized across all partnered store integrations. The system implements a unique content distribution protocol that ensures brand-provided information appears contextually alongside consumer-generated content while maintaining a clear visual distinction. Expert profiles are incorporated into the platform’s social graph, enabling direct consumer engagement through question-and-answer interfaces and live consultation features that operate within the system’s secure communication framework.

In some embodiments, the described promotional bidding system introduces novel technical mechanisms for marketplace dynamics. Retailers access real-time bidding interfaces that allow them to compete for promotional placement of products appearing in user collections. The system implements specialized algorithms that manage these time-sensitive auctions while considering factors including bid amounts, retailer reputation scores, and product relevance to current user interests. These promotional campaigns are seamlessly integrated into the user experience through dynamically generated display modules that maintain platform consistency while highlighting time-limited offers. The technical architecture simultaneously supports complex bidding scenarios across multiple product categories and geographic regions.

In some embodiments, a commission tracking infrastructure forms another innovation of the platform. The system implements blockchain-verified attribution models to accurately track user-driven sales across multiple retail experience partners. Smart contract functionality automates commission calculations and payment processing while providing transparent performance analytics through user dashboards. The technical implementation handles complex multi-tier affiliate relationships and supports various compensation models, including percentage-based earnings, fixed bounties, and performance bonuses. This monetization system is tightly integrated with the platform’s sharing features, allowing users to generate revenue through social media promotion, product advocacy, and community participation.

In some embodiments, the platform enhances user engagement through gamification systems implemented at the architectural level. Leaderboard functionality tracks and ranks user contributions across multiple dimensions, including review quality, social sharing impact, and promotional effectiveness. These competitive elements are powered by specialized analytics engines that process platform activity data in real time. The system may award achievement markers and bonus compensation through an integrated rewards framework that operates alongside the core commission structure. These motivational features are presented through visually distinctive interface elements that maintain user awareness of their standing and progress.

In some embodiments, cross-merchandising capabilities are facilitated through the platform’s advanced product relationship mapping systems. The invention implements machine learning models that identify complementary product pairings across brands and categories. These intelligent recommendations power bundled offering interfaces that brands can collaboratively manage through shared dashboard tools. The technical architecture supports complex co-marketing campaigns while maintaining clear attribution of sales and commissions across partners. Strategic brand partnerships are further enabled through shared data insights and coordinated inventory management features that operate across the platform’s retail experiences integrations.

In some embodiments, the present disclosure achieves these comprehensive functionalities through its innovative system architecture that integrates inventory management, community features, and commercial tools. The platform operates in a centralized manner while maintaining appropriate data separation between consumer, brand, and retailer domains. Machine learning algorithms enhance all aspects of the system, from personalized recommendations to promotional optimization and community content curation. This technical implementation provides users a unified shopping experience while offering brands and retailers powerful tools for customer engagement and sales conversion.

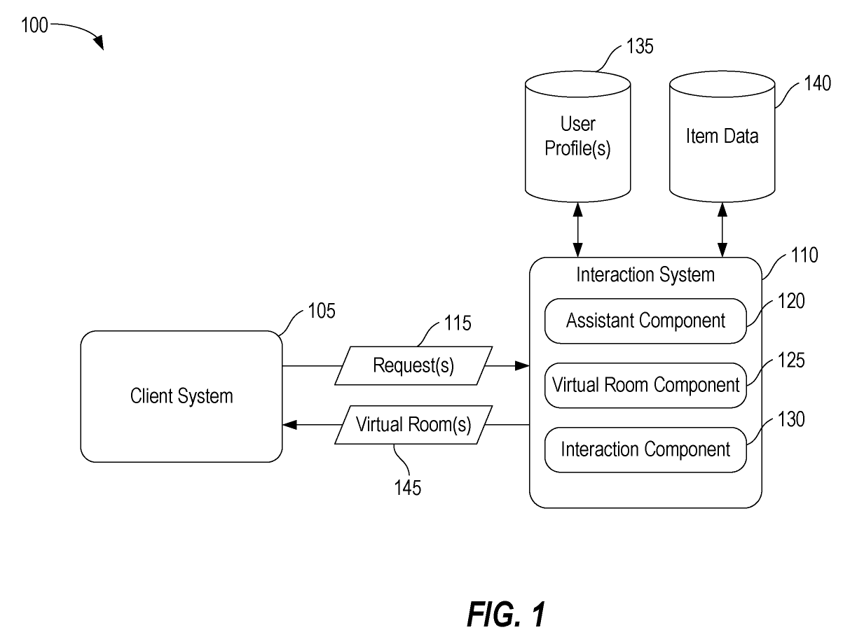

FIG. 1 depicts an example system 100 for unifying digital platforms, according to some embodiments of the present disclosure.

In the illustrated example, a client system 105 is communicatively coupled with an interaction system 110. The client system 105 and the interaction system 110 are generally representative of one or more computing systems configured to perform various aspects of the present disclosure. Although depicted as discrete physical systems for conceptual clarity, in some embodiments, the operations of the client system 105 and the interaction system 110 may be combined or distributed across any number of systems, and may be implemented using hardware, software, or a combination of hardware and software. The client system 105 and the interaction system 110 may generally be communicatively coupled via one or more communication links (including wireless links, wired links, or a combination of wired and wireless links). For example, the client system 105 and interaction system 110 may communicate via a wireless local area network (WLAN), the Internet, and the like.

In the illustrated system 100, the client system 105 is generally representative of a computing system used by one or more users, such as a smartphone, a laptop or desktop computer, a virtual reality device, and the like. As illustrated, the client system 105 can transmit requests 115 to the interaction system 110, which returns virtual rooms 145. The requests 115 are generally representative of any data request, such as a request to view recommended content items for one or more users, a request to interact with other users or services, and the like. For example, the user of the client system 105 may request to view recommended items for a particular category by clicking on or otherwise selecting an icon indicating the category, by walking in a virtual reality space to enter a virtual room corresponding to the category, and the like.

As another example, a request 115 may request information about another user’s profile, such as to view the profile virtual room for the other user (e.g., to view recommendations, suggestions, comments, posts, and other content curated by or authored by the other user).

As discussed in more detail below, the virtual rooms 145 are generally representative of any customized or personalized virtual spaces containing curated and/or selected items and data. For example, each virtual room 145 may correspond to a particular category (e.g., a food and beverage room, a sporting goods room, and the like) and may comprise or include a set of curated item suggestions, where these items may be generated or selected using trained machine learning model(s), selected by subject matter experts (e.g., designated authorities in the category), selected by other users (e.g., for the other user’s personal rooms), and the like.

As discussed above, the interaction system 110 is generally representative of a computing system (e.g., a cloud-based system, or a physical server) that provides and facilitates interactions among users and other entities (e.g., manufacturers, retailers, resellers, and the like). For example, as discussed above, the interaction system 110 may allow users to train and use customized virtual assistants (e.g., AI assistants) to generate personalized recommendations across categories, as well as to interact with the other users and entities (e.g., via corresponding chatbots or other systems for the other users and entities).

In the illustrated example, the interaction system 110 includes an assistant component 120, a virtual room component 125, and an interaction component 130. Although depicted as discrete components for conceptual clarity, the operations of the depicted components (and others not illustrated) may be combined or distributed across any number of components.

In some embodiments, the assistant component 120 may be used to generate, train, refine, and otherwise manage personalized or customized machine learning models (e.g., AI assistants) for users. In some embodiments, each user may use a corresponding personalized AI assistant (e.g., one or more machine learning models trained or fine-tuned specifically for the user) to facilitate interactions with the interaction system 110. For example, as discussed above, a recommender model may be trained based on user-provided information, such as the user’s likes and dislikes, preferences, shopping history, and the like.

In some aspects, the assistant component 120 can personalize one or more aspects of the AI agent for a given user based on user selection. For example, the assistant’s personality, visual representation, speech style, voice, and the like may be personalized based on a user selection. As one example, the user may select from a set of alternative personalities, such as a “wizard” personality, an “athlete” personality, and the like. In some embodiments, when a user interacts with their AI assistant, the agent may be represented using an avatar reflecting the selected personality.

In some embodiments, a recommendation machine learning model may be trained (e.g., based on a user profile for the user) to generate category recommendations (e.g., recommended goods and services for one or more categories) for the user. The assistant component 120 may then generate an avatar (based on the user selected personality) to represent the AI assistant. In some aspects, the avatar may be converse with the user (e.g., using a large language model (LLM) or other architecture) and present or discuss the generated recommendations in natural language while using the selected personality. For example, as discussed above, the recommendation model may generate an item recommendation, and a conversational model (e.g., an LLM) may be prompted to discuss or provide information about the item using the indicated personality.

In some embodiments, the assistant component 120 may train and refine the AI assistant(s) using information gleaned from the user profile(s) 135. Each user profile 135 may generally include information relating to a corresponding user of the interaction system 110, such as their previous purchase history, previous and/or future event(s) associated with the user (e.g., from a social calendar), budget information for the user (e.g., indicating the amount they wish to spend in total, during a given timeframe, and the like), and any other indications of preferences of the user (e.g., manually selected preferences, preferences inferred based on previous activity, and the like).

Similarly, in some embodiments, the assistant component 120 may train the assistant to generate category recommendations based on the item data 140. The item data 140 is generally representative of one or more repositories of information relating to items (which may include goods and/or services) that are available for selection (e.g., purchase) via one or more online retailers or other entities. For example, the item data 140 may include information about shoes available for purchase from one provider, information about food services available from another vendor, information about vacations that can be booked or reserved from another, and the like.

In some embodiments, within each defined item category, the assistant component 120 evaluates the item data 140 to generate a corresponding set of recommendations for each given user by processing the item data 140 using the AI assistant (e.g., recommendation model) trained for the given user (e.g., based on the corresponding user profile 135).

In some embodiments, the assistant component 120 may utilize continued learning (e.g., reinforcement learning via user behavior feedback loops) to update the personalized models. For example, based on user reactions to the assistant’s outputs (e.g., whether the user purchases a selected item), the assistant component 120 can refine the model to improve future recommendations and actions. Generally, this reinforcement can be implemented using feedback via a variety of mechanisms, including purchase history, browsing behavior, survey results, third-party integrations, and the like.

In the illustrated example, the virtual room component 125 may be used to generate and curate virtual rooms (e.g., the virtual rooms 145) based on user profiles 135 and/or item data 140. For example, given a list of category recommendations for a user (e.g., generated by the assistant component 120 for the user), the virtual room component 125 may generate a virtual room to represent the category. Each virtual room 145 is generally representative of a virtual space (e.g., a visual representation of the category) used to present the selected or recommended items. In some embodiments, a given virtual room 145 may be a curated list of items (e.g., a textual list), or may be a visual depiction of a space with the recommended item(s) dispersed around the visualization (e.g., on shelves or other objects in the room). In some embodiments, as discussed above, one or more of the virtual rooms 145 may be three-dimensional virtual scenes where the category recommendations are represented using objects (e.g., three-dimensional models) in the space.

For example, the user may approach an object in the virtual room 145 and interact with the object to receive item data 140 for the object (or responses generated based on the item data 140). As one example, as discussed above, the personalized AI assistant may use machine learning (e.g., an LLM model) to parse the corresponding item data 140 and present responses that are likely to be relevant based on the assistant’s training (e.g., based on the user profile 135). For example, if the personalized AI assistant has learned that the user usually cares most about whether the reviews or ratings for the item are good, the assistant component 120 may provide a natural language output such as “This item has the best reviews in this category, and other users rave about how convenient it is each day!” As another example, if the personalized system has learned that the user is most concerned with other aspects such as budget, the assistant may generate an output such as “The reviews on this item are still good (although not quite as impressive as the other items), but this item is significantly less expensive than other options.”

In some embodiments, as discussed above, the virtual room component 125 may generate a corresponding virtual room for each respective category, from a set of item categories. For example, the virtual room component 125 may generate a “wine” room for wine recommendations, a “vacation” room for vacation recommendations, and the like. In some embodiments, the virtual room component 125 may use a defined list of categories. In some embodiments, a user may generate their own category. For example, the user may specify or request recommendations based on a specific prompt (e.g., “show me options for a good spy-thriller novel”). In response, the assistant component 120 may generate a list of recommendations for the specified category, and the virtual room component 125 may generate a virtual room 145 to represent the category and present the items.

In some embodiments, the appearance of a given virtual room 145 may vary depending on user preference or selection and/or based on the contents of the room. For example, for a “wine” category, the user may specify the appearance or ambience, such as indicating that the virtual room 145 should have the appearance of a wine cellar, a vineyard, and the like. As another example, the virtual room component 125 (or another component) may evaluate the category name, description, and/or the list of recommended items to generate a virtual room 145 with an ambience that fits the category or items. For example, if the category corresponds to novels about detectives, the virtual room component 125 may generate a virtual room 145 having a corresponding ambience that fits the theme. As another example, if the recommended items are largely (or exclusively) from a given region (e.g., French wines), the virtual room component 125 may generate a virtual room 145 representative of this region (e.g., a boutique with a view of the Eiffel tower).

As discussed above, the user may (via the client system 105) enter a virtual room 145 in response to requests 115. For example, the user may click a link or UI element, or may enter the room by moving in the virtual space (e.g., by moving an avatar representing the user through a three-dimensional scene to enter the virtual room 145). The interaction system 110 may, in response, transmit the virtual room 145 (including objects and items therein, such as the generate category recommendations) for output via the client system 105.

In some embodiments, as discussed above, one or more of the virtual rooms 145 may have a corresponding authority FIGURE(e.g., an avatar representing a subject matter expert for the category). For example, a “golf” room may include a professional golfer. In some embodiments, the virtual room component 125 may add the avatar of the authority to the virtual room 145, allowing the user to interact with the authority figure. For example, the user may ask questions about various items in the room, and the virtual room component 125 may use one or more conversational models (e.g., an AI assistant trained or refined based on the subject matter expert) to generate corresponding responses.

In some aspects, as discussed above, the user may interact with the objects in the virtual room 145 and select one or more for purchase. In response, in some embodiments, the virtual room component 125 may provide a link to where the item can be purchased (e.g., on the website of the corresponding digital platform), allowing the user to leave the virtual room 145 and interaction system 110 to finalize the selection. In some embodiments, the interaction system 110 can update the user profile 135 based on this selection, allowing the assistant and model(s) to be further refined based on the user’s activity.

In the illustrated system 100, the interaction component 130 may be used to facilitate or enable interaction among users and other entities (e.g., brands, retailers, and the like) in the interaction system 110. For example, as discussed above, the interaction component 130 may generate a profile virtual room for a user based on a list of items selected by the user (e.g., items the user has previously purchased, items the user has expressed interest in such as by adding it to a “favorite” or “wish” list, and the like) in a similar manner to the category-specific virtual rooms 145. The interaction component 130 may further generate a link to the profile virtual room, allowing the user to share their selected information with other users of the interaction system 110.

For example, a user may enter another user’s personal profile room (e.g., via a provided link) to view and interact with the user’s curated item selections. In some aspects, as discussed above, these profile rooms may operate in a similar manner to the category-specific virtual rooms, allowing users to interact with the objects depicted therein in order to gain additional understanding. In some embodiments, the profile virtual room may include an avatar representative of the corresponding user (e.g., having an appearance and personality specified by the user), allowing visiting users to discuss the items with a virtual representative of the user.

In some embodiments, users may select items from a profile virtual room in a similar manner to the category-specific rooms, as discussed above. For example, while interacting with another user’s room, a given user may decide to select one of the items, and the interaction system 110 may generate and transmit a link allowing the user to finalize the selection (e.g., with a link to the digital platform where the item can be purchased). In some embodiments, the interaction component 130 may update a leaderboard or other tracking system based on this selection.

For example, the interaction component 130 may allocate or award points to the user associated with the room (e.g., the user that curated the profile room) based on the selection. These points may be assigned based on factors such as the value of the item that was selected, the number of times other users have decided to purchase the item after visiting the user’s room, and the like. In some embodiments, the interaction component 130 may maintain category-specific leaderboards indicating, for each category, the most influential person (e.g., the user having the highest number of points).

In some embodiments, the interaction component 130 may additionally or alternatively award other rewards, such as commissions, based on the selection. For example, if other users decide to purchase an item in a given user’s personal profile room, the given user may receive a commission (e.g., a percentage of the price), rewarding the user for their useful suggestions.

In some aspects, the user’s personalized AI assistant may assist and/or manage a variety of data and systems for the user, potentially linking or tying such data together to enable unified and immersive assistance. For example, the personalized assistant may manage the user’s calendar and offer help based on preferences and other data (such as the user’s financials or banking information) to unify the user’s upcoming events and financials. In some aspects, this assistance can facilitate or enable improved interactions, such as shipping requested items directly to the user. In some aspects, each data service or system (e.g., calendar information, financial information, and the like) may be selectively evaluated individually and/or collectively depending on client preference and permissions.

In some embodiments, the interaction system 110 may, via the personalized AI assistant, implement a variety of functionalities depending on the particular preferences and desires of the user. For example, the interaction system 110 may act as a personal shopper for the user (e.g., automatically selecting and suggesting items the user may be interested in), a personal assistant for the user (e.g., responding to user inquiries and providing useful assistance and information), a personal social calendar manager for the user (e.g., keeping track of scheduled events, providing reminders, suggesting additional events, and/or suggesting items that may be useful for upcoming events), and/or a personal financial guide for the user (e.g., helping the user to create and follow a budget based on their information and items they are interested in).

In some embodiments, for example, the user’s AI assistant may therefore provide improved functionality such as budget tracking, event scheduling, financial guidance, calendar integrations, and the like. In some aspects, the assistant may dynamically switch roles depending on the user query, such as acting and responding as a personal shopper, accountant, scheduler, and the like depending on the context of the user request.

In some embodiments, some or all of the functionality of the interaction system 110 can be provided via white-labeled interfaces (e.g., application programming interfaces (APIs)) that expose the available functionality (e.g., the operations of the AI assistant) to other platforms. This can allow such other platforms to integrate the functionality of the interaction system 110 (e.g., via API calls to the interaction system 110), enabling embedded assistant experiences in these other platforms.

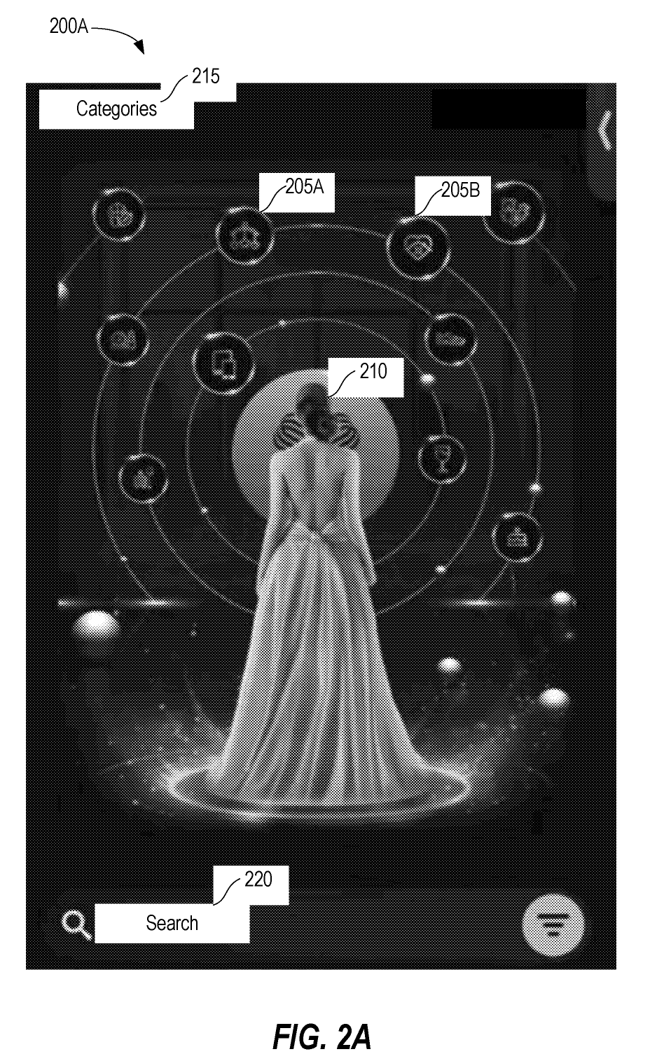

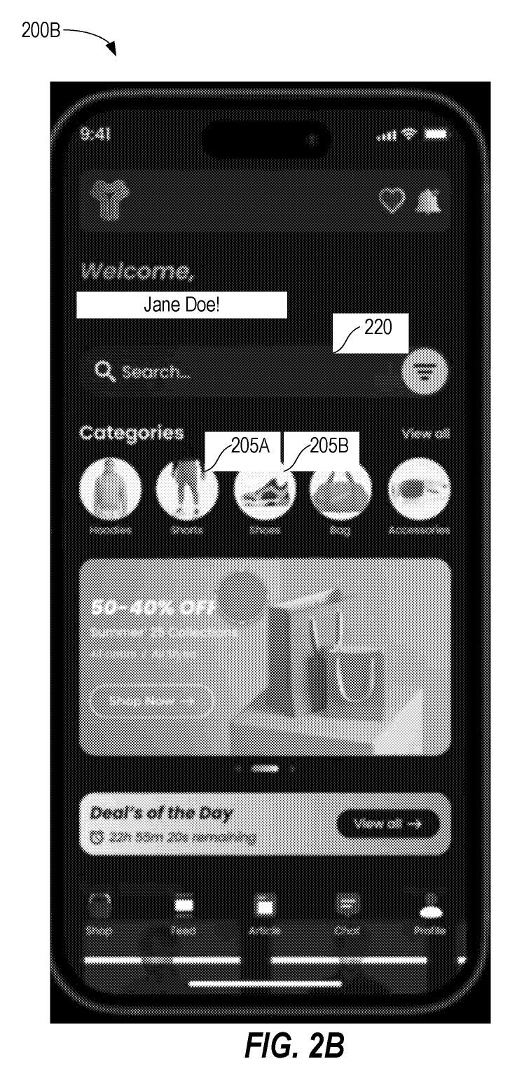

FIGS. 2A and 2B depict example profile virtual rooms 200A and 200B for unifying digital platforms, according to some embodiments of the present disclosure. In some embodiments, the profile virtual rooms correspond to virtual rooms (e.g., the virtual rooms 145 of FIG. 1) generated by an interaction system (e.g., the interaction system 110 of FIG. 1) to contain or present information for a specific user.

As illustrated in FIG. 2A, the profile room 200A is a three-dimensional virtual scene is depicted where a user may interact, via their avatar 210, with various objects or elements 205A-B in the space. For example, in some aspects, the profile room 200A may correspond to an initial room where the user can enter other virtual rooms (e.g., category-specific rooms) by interacting with corresponding elements 205A-B. As discussed above, these category-specific rooms may include a variety of recommendations generated using the user’s personalized AI assistant.

In some embodiments, some or all of the elements 205 may alternatively represent items selected by the user. For example, as discussed above, the user may have a personalized profile virtual room to contain or present information about items they have specifically curated or selected, and the elements 205 may be interacted with to review additional information about these items.

In some embodiments, the avatar 210 represents the user in the virtual space. For example, the user may generate an avatar by selecting the appearance, personality, or other aspects that they wish to use to represent themselves in the interaction system. In some aspects, the avatar 210 may not be visible to the user (e.g., if the user interacts with the systems in a first-person view). In some embodiments, when other users visit the personal profile room of the given user, the given user’s avatar 210 may be depicted in the room (e.g., to greet the visitors and discuss the selected items).

In some aspects, the user may interact with the objects in the virtual space using various input devices, such as using a touchscreen, using a keyboard and/or mouse, using a virtual reality device, and the like. For example, in some aspects, the user may click on or tap the elements 205 to view additional information and/or enter the corresponding room(s). As another example, in some aspects, the user may approach the elements 205 in the space (e.g., moving the avatar 210 through the virtual space) and enter or otherwise interact with the objects.

In the illustrated example, the user’s profile virtual room 200A also includes an element 215 to view or curate categories that are available to the user (e.g., to select which categories should have a corresponding virtual room for the user, indicating that the user desires recommendations for these categories). For example, the user may interact with the element 215 to select which item categories should be included in their profile virtual room 200A.

Additionally, in the illustrated example, the profile virtual room 200A includes an element 220 to search the interaction system. For example, the user may use the element 220 to initiate a search for other users of the platform, for other digital platforms that are integrated with the interaction system, for specific items, and the like.

Generally, the profile virtual room of a user may take many forms, and the profile virtual room 200A of FIG. 2A is merely one example.

Turning now to FIG. 2B, another profile virtual room 200B is depicted. In this example, rather than depicting the profile room as a three-dimensional space, the interaction system has generated a graphical user interface (GUI) having textual and/or visual elements 205 that the user can interact with (e.g., by tapping them on a smartphone). Specifically, as illustrated, the profile virtual room 200B includes elements 205A-B to allow the user to view or enter virtual rooms corresponding to specific categories such as “hoodies,” “shorts,” “shoes,” “bags,” and “accessories.”

In some aspects, as discussed above, some or all of the elements 205 may alternatively correspond to items selected or curated by the user (e.g., specific shoes they recommend, locations they want to visit, and the like). Further, as discussed above, the profile virtual room 200B includes an element 220 to allow the user to search the interaction system.

In some aspects, the profile virtual room 200B and the profile virtual room 200A may correspond to two different visualizations or presentations for a single virtual room. For example, depending on the particular device that the user is using to interact with the interaction system and/or the particular format of the user request, the interaction system may generate or provide a different version of the profile room. As one example, if the user requested a simplified room formatted using an accessible GUI with minimal overhead, the interaction system may generate and/or return the profile virtual room 200B, which can be easily interacted with using traditional smartphone inputs. As another example, if the user requested a more immersive three-dimensional room, the interaction system may generate or return the profile virtual room 200A of FIG. 2A, which may provide additional interactivity.

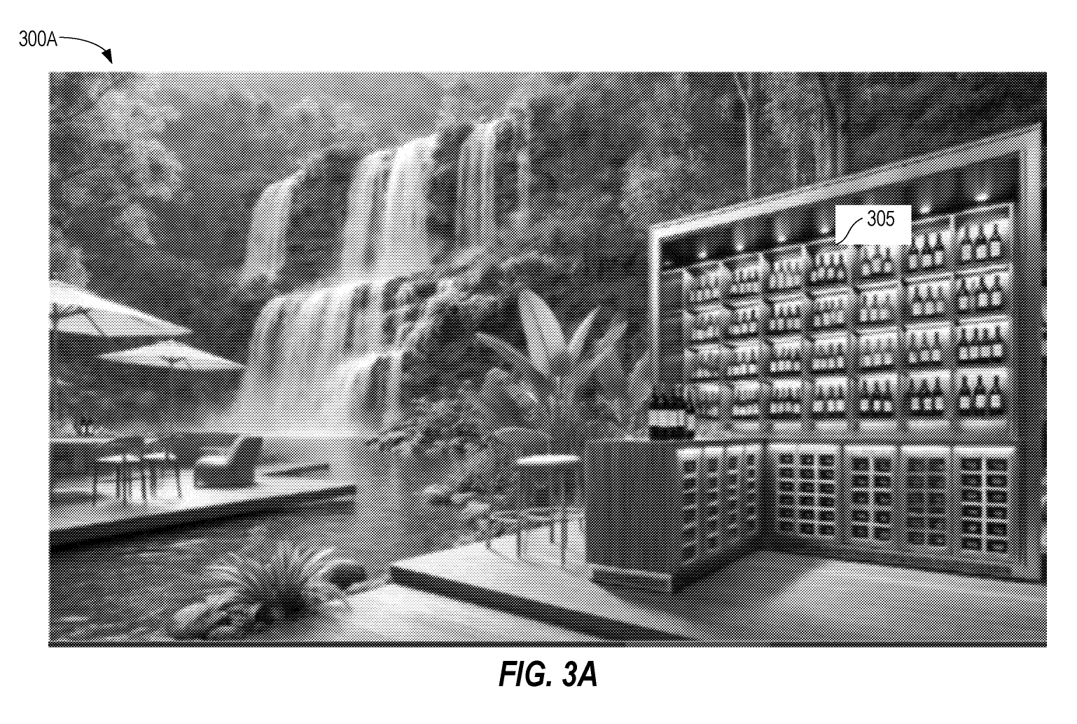

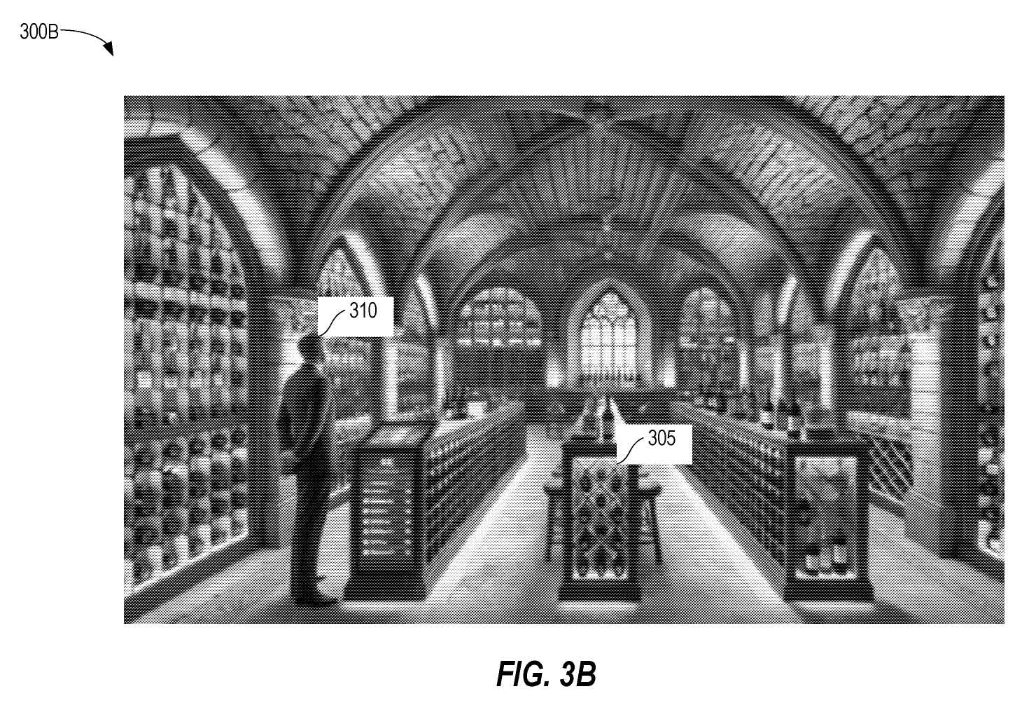

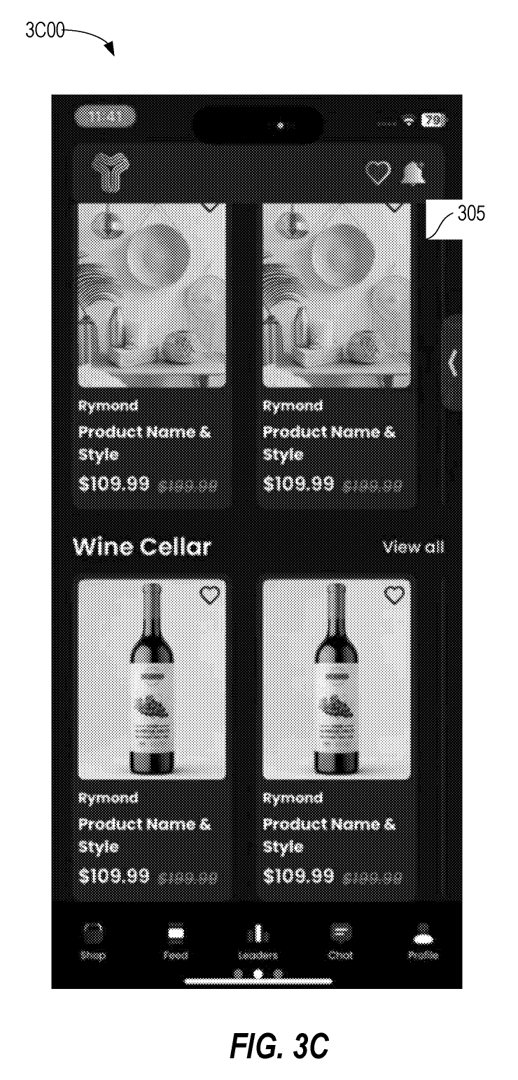

FIGS. 3A, 3B, and 3C depict example virtual rooms 300 for category-specific platform unification, according to some embodiments of the present disclosure. In some embodiments, the virtual rooms 300 correspond to the virtual rooms 145 of FIG. 1, and may be generated by an interaction system (e.g., the interaction system 110 of FIG. 1) to contain or present information relating to item recommendations for a particular category (e.g., category recommendations).

As discussed above, in some embodiments, the interaction system may personalize or customize the appearance and ambience of the virtual rooms based on aspects such as the preferences of the user, the context of the category, the contents of the recommended items list, and the like. For example, the virtual rooms 300A 300B, and 300C of FIGS. 3A, 3B, and 3C, respectively, depict three visualizations for a “wine” virtual room.

Specifically, as illustrated in FIG. 3A, a virtual room 300A is a three-dimensional scene corresponding to an outdoor area near a waterfall. As illustrated, the objects 305 (e.g., category recommendations, such as specific bottles of wine) are depicted in a display (e.g., a shelf), while the rest of the virtual room 300A provides a desired ambience and atmosphere. For example, as discussed above, the user may specify that they would like their “wine” item recommendations to be depicted in an outdoor space near water, and the interaction system may generate the virtual room 300A in response.

In some embodiments, rather than specifying the desired appearance of the virtual room 300A, the interaction system may infer or select an appearance based on information such as the user’s preferences or historical actions (e.g., using one or more machine learning models to infer what ambience the user would like for the room). As another example, the interaction system may evaluate the context of the room (e.g., the category description) to generate the room. As yet another example, the interaction system may evaluate the contents of the room (e.g., the specific category recommendations that were generated, for the user, using the user’s personalized AI assistant) to generate the virtual room 300A.

As discussed above, in some aspects, the user may move through the virtual room 300A and/or interact with the objects 305 using various input means (e.g., a keyboard, a mouse, a touchscreen, a virtual reality system, and the like) to view information about the items.

In some embodiments, as discussed above, the objects 305 may represent items associated with or corresponding to multiple different digital platforms. In some embodiments, to unify these platforms, the interaction system may generate a new object 305 to represent each item (rather than simply copying the pictures provided by the other platforms), ensuring an integrated and immersive experience (e.g., such that the objects 305 appear to correspond to a single source). For example, the interaction system may generate a three-dimensional “wine bottle” object, and modify the label of each such object based on the corresponding item (e.g., the specific bottle of wine) that the object represents. This can allow the user to interact with appropriate objects 305 that have a unified appearance while maintaining the relevant information. When user selects or picks up one of the objects 305, the interaction system (or the user’s virtual assistant) may provide additional information (e.g., “that bottle is made from a blend of Merlot and Cabernet Franc grapes by a winery in France that is several hundred years old,” or “sommeliers indicate that this bottle has hints of chocolate with a full mouthfeel”).

Although not depicted in the illustrated example, in some aspects, the avatar of the user’s personalized AI assistant may be depicted in the virtual room 300A to assist the user, such as to answer any questions about the items (e.g., using a retrieval-augmented generation (RAG) approach). For example, the interaction system may retrieve contextual information about the selected item (e.g., from the corresponding digital platform) and generate appropriate summaries for the item (e.g., in response to user inquiries). In some embodiments, the interaction system may generate these responses based in part on the profile of the user (e.g., taking into account the user’s historical preferences, such as to emphasize the ingredients used, whether the item is organic, and the like).

In some embodiments, as discussed above, the personality of the user’s AI assistant may dynamically change based on the virtual room 300A and/or the objects 305 therein. For example, the interaction system may change the clothing, speech (e.g., voice, accent, and the like), appearance, utterances (e.g., phrases used), or other attributes of the avatar to fit the ambience of the virtual room 300A. As another example, the interaction system may change such attributes of the avatar based on the particular items (e.g., changing accents to the region from which an item is sourced, when the user selects or asks for more information about the item).

Similarly, although not depicted in the illustrated example, in some aspects the interaction system may also add an avatar corresponding to an authority figure for the category to the virtual room 300A. For example, an avatar of a sommelier may be located in the virtual room 300A. This authority figure may present additional manually curated items (e.g., selected by the corresponding subject matter expert) and/or may provide relevant information, such as articles written by the expert.

Turning now to FIG. 3B, another example virtual room 300B is depicted. In the illustrated example, the virtual room 300B is a three-dimensional scene corresponding to a wine cellar. As illustrated, the objects 305 (e.g., category recommendations, such as specific bottles of wine) are depicted in a display (e.g., a shelf), while the rest of the virtual room 300B provides a desired ambience and atmosphere. For example, as discussed above, the user may specify that they would like their “wine” item recommendations to be depicted in a wine cellar, and the interaction system may generate the virtual room 300B in response.

In some embodiments, rather than specifying the desired appearance of the virtual room 300B, as discussed above, the interaction system may infer or select an appearance based on information such as the user’s preferences or historical actions, the context of the room (e.g., the category description), the contents of the room (e.g., the specific category recommendations that were generated, for the user, using the user’s personalized AI assistant), and the like.

In the illustrated example, the objects 305 are similarly represented using generated three-dimensional models arranged around the virtual space, such as in racks or shelves in the wine cellar. As discussed above, in some embodiments, the user may interact with the objects 305 to receive additional information (e.g., via their personalized AI assistant).

In the illustrated example, the virtual room 300B includes an avatar 310, which may represent the user’s assistant and/or an authority FIGURE(e.g., subject matter expert) for the category. For example, the avatar 310 may represent a Chatbot trained and/or used by a subject matter expert (e.g., a sommelier) to present curated items selected by the expert and/or to respond to user inquiries related to the category. As another example, the avatar 310 may be the users own assistant, included to discuss or provide information for the specific objects 305 that were selected or recommended by the users personalized recommendation models. In some embodiments, as discussed above, the appearance of the avatar 310 may be dynamically modified to reflect the virtual room 300B (e.g., wearing a professional suit in the illustrated example) and/or based on the particular objects contained therein.

Turning now to FIG. 3C, another example virtual room 300C is depicted. In the illustrated example, the virtual room 300C is a list-based two-dimensional GUI corresponding to the win category. That is, rather than generating a three-dimensional virtual space for the category, the interaction system generated a two-dimensional virtual room 300C that includes textual and/or visual representations of the category recommendations.

As illustrated, the objects 305 (e.g., category recommendations, such as specific bottles of wine) are depicted as a grid of options (where each includes a picture, as well as item-specific information such as the name, price, and the like). The rest of the virtual room 300C does not include any particular ambience or atmosphere, as compared to the virtual rooms 300A and 300B. For example, as discussed above, the user may specify that they would like their “wine” item recommendations to be depicted as a simplified list, rather than in an immersive virtual space.

In some embodiments, rather than specifying the desired appearance of the virtual room 300C, as discussed above, the interaction system may infer or select an appearance based on information such as the user’s preferences or historical actions, the context of the room (e.g., the category description), the contents of the room (e.g., the specific category recommendations that were generated, for the user, using the user’s personalized AI assistant), and the like.

In the illustrated example, the user may interact with the objects 305 to receive additional information (e.g., via their personalized AI assistant). For example, the user may click or tap a given item to receive textual information describing the item (e.g., a summary generated using the user’s AI assistant).

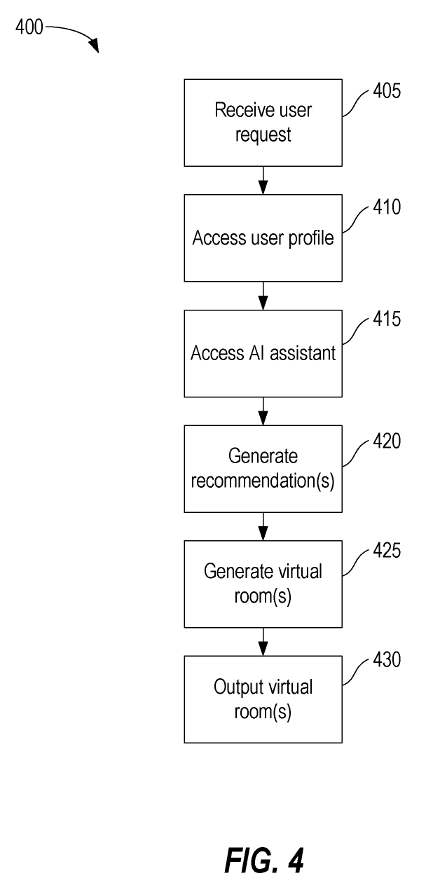

FIG. 4 is a flow diagram depicting an example method 400 for generating personalized models for information management, according to some embodiments of the present disclosure. In some embodiments, the method 400 is performed by an interaction system, such as the interaction system 110 of FIG. 1.

At block 405, the interaction system receives a user request (e.g., the request 115 of FIG. 1). As discussed above, the request may generally include a request for specific information or data (e.g., to view a particular profile virtual room corresponding to a specific user), a request for general information (e.g., a request to review category recommendations for one or more categories), and the like. In some aspects, as discussed above, the request may be received as the user interacts with the interaction system, such as by clicking a link, virtually walking through a door or portal, and the like.

At block 410, the interaction system accesses a user profile for the user that provided the request. As used herein, “accessing” data may generally include receiving, retrieving, obtaining, collecting, generating, requesting, or otherwise gaining access to the data. For example, the interaction system may retrieve the user profile from a repository of profiles (e.g., the user profiles 135 of FIG. 1) if one already exists for the user (e.g., the user is not a new user), or may generate a new profile if the request corresponds to a new user.

As discussed above, the user profile may generally include information about the user such as their preferences, survey responses, previous purchases or browsing history, wish lists, geographic location, calendar events, budget, and the like.

At block 415, the interaction system accesses a personalized AI assistant for the user. In some embodiments, as discussed above, the AI assistant may refer to a collection of one or more machine learning models trained based on the user profile or other data specific to the user, such as a recommendation model (e.g., to recommend or rank potential items for the user), a language model (e.g., to engage in natural language discussions with the user regarding the recommendations or other information), and the like.

In some embodiments, the personalized AI assistant may be continuously updated and refined as the user interacts with the interaction system (e.g., based on the user’s conversations, item selections, and the like). In some embodiments, if the request was received from a new user, the interaction system may access a pre-trained or default assistant (e.g., trained in a user-agnostic manner). This default assistant may then be personalized for the particular user, such as based on data contained in the user profile, user responses to surveys or questionnaires, and the like.

In some aspects, as discussed above, the personality and/or appearance of the AI assistant may also be personalized for the user. For example, as discussed above, the user may provide a description of their desired personality (e.g., “make my assistant a wizard with a long white beard”), or may select their desired personality from a set of alternative options. In some aspects, this personality may be reflected in the avatar used to represent the personalized AI assistant. For example, the visual depiction of the assistant (e.g., in the virtual rooms) may have an appearance that matches the personality. As another example, when generating conversational responses (e.g., using a language model), the personality of the assistant may be included as contextual input to the model to ensure that the output aligns with the desired assistant personality.

At block 420, the interaction system generates a set of recommendations (referred to in some aspects as item recommendations or category recommendations) using the AI assistant. For example, as discussed above, the interaction system may, for a given category of goods or services, evaluate a set of options (e.g., reflected in the item data 140) to generate a corresponding set of recommended items for the user. As discussed above, by using the personalized AI assistant (e.g., the fine-tuned recommendation model) to generate the recommendations, the interaction system can ensure that the recommended items are aligned with the user’s intent and preferences.

In some embodiments, as discussed above, these item recommendations are generated based on details such as the user’s expressed or inferred preferences, prior browsing or interactions, budget (e.g., to ensure that the recommended items fit within the user’s budget), and the like.

In some embodiments, the interaction system may additionally or alternatively evaluate information such as a calendar of events associated with the user. For example, the interaction system may evaluate the user’s calendar to identify upcoming events for which one or more item(s) should be recommended (e.g., events where gifts are traditionally exchanged), such as upcoming birthday parties, housewarming parties, weddings, and the like.

In some embodiments, if the calendar event indicates the recipient (either specifically identifying the recipient user, or generally indicating characteristics of the user such as by indicating that it is a “4^{th} birthday party”), the interaction system may use this information to generate recommendations. For example, if an event specifies “User1’s birthday”, the interaction system may retrieve User1’s profile to determine their preferences, desires, and the like. The interaction system can then evaluate alternatives in view of these preferences in order to generate recommendations. As another example, if the event has a title or description such as “Join us for John’s bowling birthday”, the interaction system may generate recommendations related to bowling. In some embodiments, the recommendations may be generated based at least in part on how much time remains until the scheduled event. For example, the interaction system may ensure that any suggested items can be shipped and delivered sufficiently in advance of the event.

At block 425, the interaction system generates one or more virtual rooms (e.g., the virtual rooms 300A-C of FIGS. 3A, 3B, and/or 3C) based on the recommendations. For example, as discussed above, the interaction system may generate a virtual room having a particular ambience or environment as specified by the user, inferred based on the context, or otherwise determined by the interaction system. In some embodiments, as discussed above, the interaction system may determine whether to generate an immersive three-dimensional virtual space or a simplified virtual room (e.g., a two-dimensional list or grid of suggestions) based on user preference or configuration.

In some aspects, as discussed above, part of generating the virtual room may include generating object entities to represent each item in the list of recommended items for the category. These object entities may then be added to the virtual room to enable immersive browsing. In some embodiments, as discussed above, generating the virtual room may include customizing the appearance, personality, utterances (e.g., customizing the particular phrases used and/or the spoken accent of the avatar), or other aspects of the user’s personalized AI assistant.

For example, as discussed above, the interaction system may change the AI assistant’s clothing to sporting equipment for a sporting goods virtual room, to a ball gown for an elegant evening category, to an athletic team’s jersey for a professional sports tickets category, and the like.

In some aspects, as discussed above, generating the virtual room may also include customizing the AI assistant’s avatar based on the particular items on the recommended list. For example, when discussing tickets for an event in a particular locale, the AI assistant may speak with an accent of the location, or may use colloquialisms that are popular in the location.

In some aspects, generating the virtual room can include generating and adding an avatar of an authority FIGURE(e.g., a designated subject matter expert) to the virtual room, as discussed above.

At block 430, the interaction system outputs the generated virtual room(s) responsive to the request. For example, as discussed above, the interaction system may transmit the virtual rooms to a client device, such as a smartphone, virtual reality device, and the like. In some embodiments, the particular techniques used to output the virtual rooms may vary depending on the particular implementation. For example, if the virtual room is a three-dimensional virtual space, outputting the virtual room may include rendering the space and allowing the user to move through the virtual space to interact with objects therein. If the virtual room is a simplified GUI, outputting the virtual room may include displaying the recommendations in a list.

In these ways, the interaction system can unify disparate digital platforms and provide a seamless and engaging system for interaction and data exchange, as discussed above.

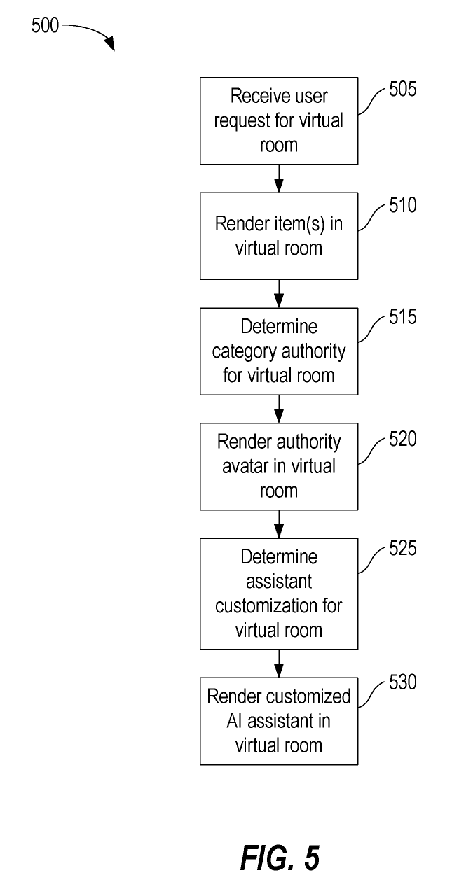

FIG. 5 is a flow diagram depicting an example method 500 for generating and rendering customized virtual rooms, according to some embodiments of the present disclosure. In some embodiments, the method 500 is performed by an interaction system, such as the interaction system 110 of FIG. 1. In some embodiments, the method 500 provides additional detail for block 425 of FIG. 4.

At block 505, the interaction system receives a user request for a virtual room. For example, as discussed above, the user may request the virtual room by selecting the corresponding category (e.g., clicking a link), or by entering the room in a virtual space (e.g., causing an avatar representing the user to walk or move to the room and enter a doorway, portal, or other means of entering the room).

At block 510, responsive to this request, the interaction system renders items or objects in the virtual room based on the set of category recommendations generated, for the user, with respect to the corresponding category. For example, as discussed above, the interaction system may generate or retrieve three-dimensional models to represent the items, and arrange these items in designated areas in the virtual room (e.g., on shelves, tables, and the like). In some aspects, the appearance of these rendered objects may be dynamically modified based on the corresponding recommendations (e.g., to add a label of the item).

At block 515, the interaction system determines a category authority for the virtual room. For example, as discussed above, the interaction system may identify the user(s) that are designated as the authority or expert with respect to the category to which the room corresponds.

At block 520, the interaction system renders an authority avatar (e.g., an avatar for a Chatbot representative of the authority figure) in the virtual room. For example, as discussed above, the authority avatar may greet the user as they enter the room, or may stand to the side and await any questions from the user.

At block 525, the interaction system determines any relevant assistant customizations for the virtual room. For example, as discussed above, the interaction system may determine whether to customize the personal assistant’s appearance, accent, speech, personality, and the like based on the category and/or room. As one example, the AI assistant may wear clothing that corresponds to the category, or may change appearance to better reflect the ambience of the specific virtual room. As yet another example, the AI assistant may use different speech or appearance based on the particular item(s) being discussed.

At block 530, the interaction system renders the customized AI assistant in the virtual room. For example, as discussed above, the interaction system may render an avatar representative of the personalized assistant in the room. This avatar may greet the user, point out specific items, respond to inquiries regarding any items, and the like.

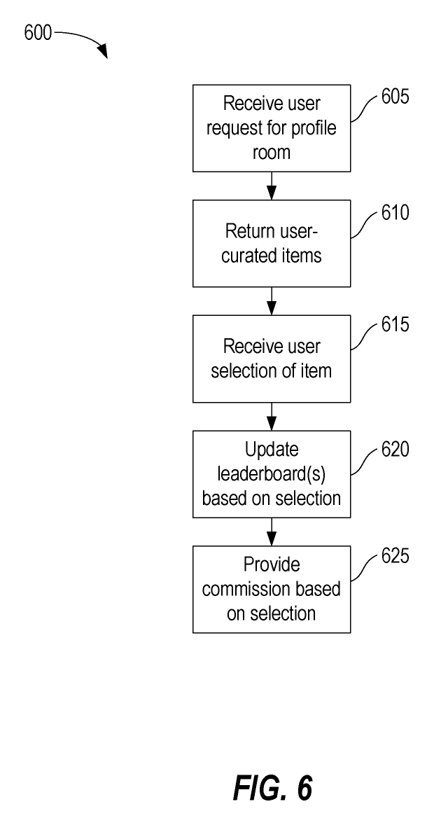

FIG. 6 is a flow diagram depicting an example method 600 for efficient information sharing, according to some embodiments of the present disclosure. In some embodiments, the method 600 is performed by an interaction system, such as the interaction system 110 of FIG. 1.

At block 605, the interaction system receives a user request for a profile room (e.g., a request to visit or view the profile virtual room of another user). For example, as discussed above, this request may correspond to the user clicking a link for the other user, entering a portal or room corresponding to the other user, and the like. As discussed above, the profile room may generally correspond to a virtual room where selections and information curated by and/or authored by the corresponding user are provided. For example, the profile room may include objects representing items that the user recommends or likes, objects the user is interested in or may want to purchase, and the like.

At block 610, the interaction system returns the user-curated items in the virtual room. For example, as discussed above, the profile room may comprise a three-dimensional or two-dimensional space where the user-curated items are arranged in a similar manner to the category-specific rooms discussed above.

At block 615, the interaction system receives a user selection of one of the user-curated items. For example, as discussed above, the visiting user may select one of the items to indicate that they plan to purchase the item. As discussed above, responsive to this selection, the interaction system may provide a link or otherwise facilitate the user moving to the digital platform that corresponds to the item.

At block 620, the interaction system updates one or more leaderboard(s) based on the user selection. For example, as discussed above, the interaction system may assign points to the curating user (e.g., the user to which the profile room corresponds) to reflect that the visiting user selected or approved one of the curated items. In some embodiments, updating the leaderboard is performed in response to confirming that the user finalized their selection (e.g., after the user purchases the item), rather than immediately upon receiving the user selection.

At block 625, the interaction system provides a commission to the curating user based on the selection. For example, as discussed above, the interaction system may ensure that a fee determined based on the price of the item is provided to the user. In some aspects, as above, the commission may be awarded in response to confirming that the selection was finalized by the visiting user. For example, as discussed above, the commission may be a monetary reward determined based on a conversion, from an external platform, via the user’s link or item selection. In some embodiments, this enables the user to monetize their curated room(s). Further, as discussed above, this curation can facilitate gamification via aspects such as leaderboards (e.g., tracking the most influential users across various categories), badges or other visual indicators of influence (e.g., on the user’s profile or in the curated room), and the like.

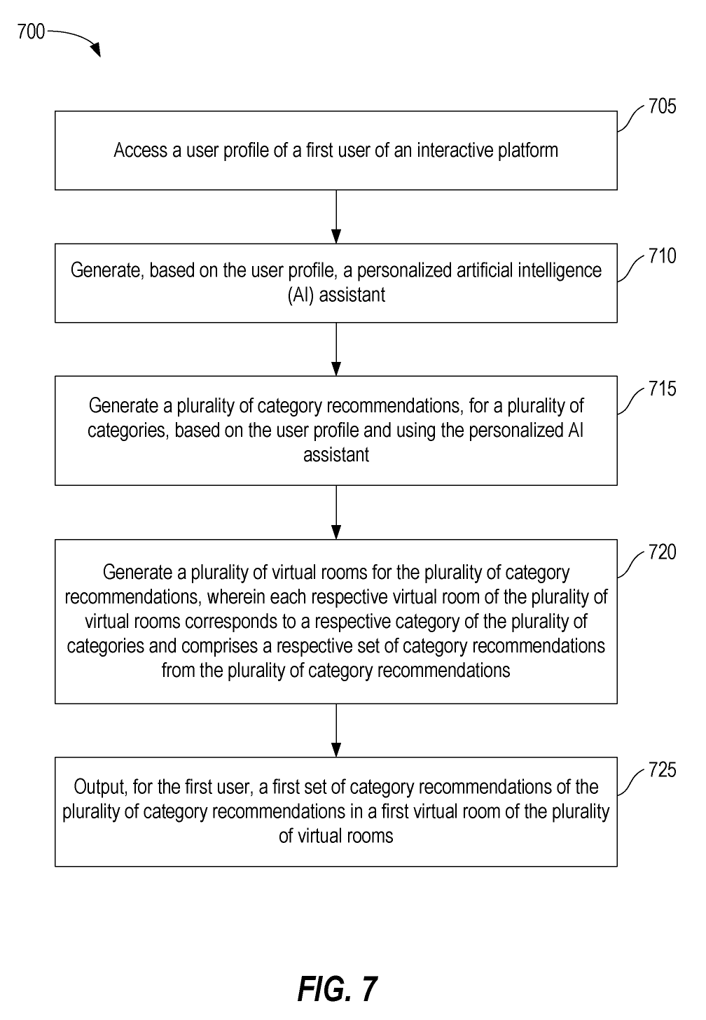

FIG. 7 is a flow diagram depicting an example method 700 for generating category recommendations, according to some embodiments of the present disclosure. In some embodiments, the method 700 is performed by an interaction system, such as the interaction system 110 of FIG. 1.

At block 705, a user profile (e.g., from the user profiles 135 of FIG. 1) of a first user of an interactive platform (e.g., the interaction system 110 of FIG. 1) is accessed.

At block 710, based on the user profile, a personalized artificial intelligence (AI) assistant (e.g., the assistant component 120 of FIG. 1) is generated.

At block 715, a plurality of category recommendations is generated, for a plurality of categories, based on the user profile and using the personalized AI assistant.

At block 720, a plurality of virtual rooms (e.g., the virtual rooms 145 of FIG. 1) is generated for the plurality of category recommendations, wherein each respective virtual room of the plurality of virtual rooms corresponds to a respective category of the plurality of categories and comprises a respective set of category recommendations from the plurality of category recommendations.

At block 725, a first set of category recommendations of the plurality of category recommendations is output, for the first user, in a first virtual room of the plurality of virtual rooms.

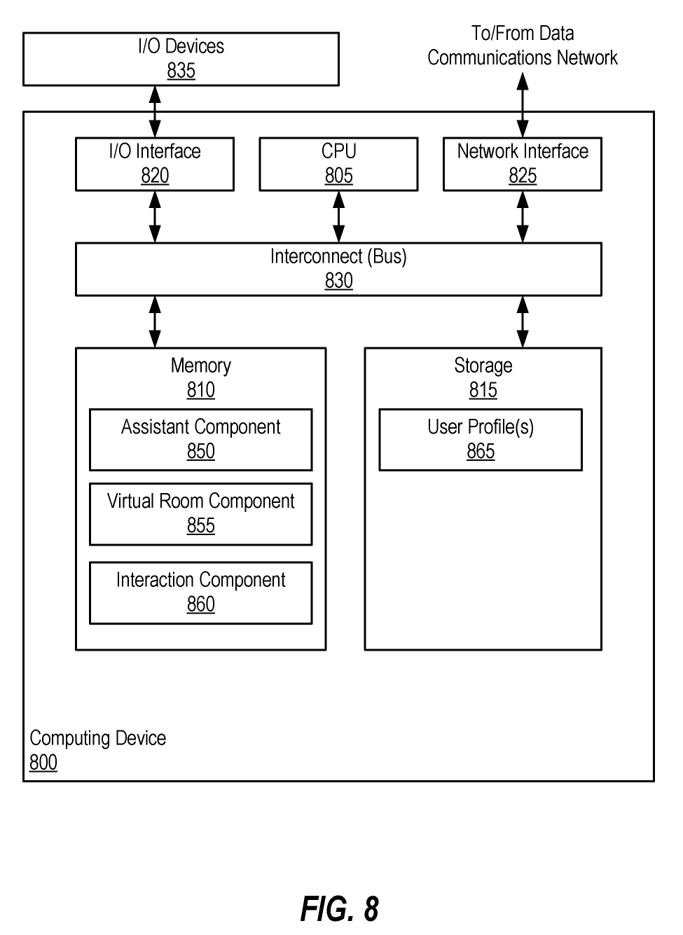

FIG. 8 depicts an example computing device 800 configured to perform various embodiments of the present disclosure. Although depicted as a physical device, in embodiments, the computing device 800 may be implemented using any number of virtual or physical device(s) (e.g., in a cloud environment). In one embodiment, the computing device 800 corresponds to or implements an interaction system, such as the interaction system 110 of FIG. 1.

As illustrated, the computing device 800 includes a CPU 805, memory 810, a network interface 825, and one or more I/O interfaces 820. Though not included in the depicted example, in some embodiments, the computing device 800 also includes one or more storages. In the illustrated embodiment, the CPU 805 retrieves and executes programming instructions stored in memory 810, as well as stores and retrieves application data residing in memory 810, storage (not depicted), or both. The CPU 805 is generally representative of a single CPU, a single GPU, multiple CPUs, multiple GPUs, a single CPU having multiple processing cores, a single GPU having multiple processing cores, and the like. The memory 810 is generally included to be representative of a random access memory. In an embodiment, if storage is present, it may include any combination of disk drives, flash-based storage devices, and the like, and may include fixed storage devices, removable storage devices, or both (such as fixed disk drives, removable memory cards, caches, optical storage, network attached storage (NAS), or storage area networks (SAN)).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, network interface(s) 825, and I/O interface(s) 820 are communicatively coupled by one or more buses 830.

In the illustrated embodiment, the memory 810 includes an assistant component 850, a virtual room component 855, and an interaction component 860, which may perform one or more embodiments discussed above. Although depicted as discrete components for conceptual clarity, in embodiments, the operations of the depicted components (and others not illustrated) may be combined or distributed across any number of components. Further, although depicted as software residing in memory 810, in embodiments, the operations of the depicted components (and others not illustrated) may be implemented using hardware, software, or a combination of hardware and software.

The assistant component 850 (which may correspond to the assistant component 120 of FIG. 1) may generally be used to generate and utilize personalized AI assistants, as discussed above. For example, the assistant component 850 may fine-tune one or more machine learning models (e.g., recommendation models, language models, and the like) based on user-specific data in order to generate a personalized assistant that can be used to generate recommendations for the user, to discuss the recommendations, and the like.

The virtual room component 855 (which may correspond to the virtual room component 125 of FIG. 1) may generally be used to generate virtual rooms (e.g., the virtual rooms 145 of FIG. 1), as discussed above. For example, the virtual room component 855 may determine or infer the atmosphere and style of a virtual room for a given category based on the category description, user preference, and the like. The virtual room component 855 may then generate a virtual room (e.g., using generative AI), along with a set of objects (e.g., three-dimensional models) to represent the corresponding items in the category.

The interaction component 860 (which may correspond to the interaction component 130 of FIG. 1) may generally be used to facilitate or perform interactions among users, as discussed above. For example, the interaction component 860 may track user browsing and selections in other user’s profile rooms in order to update leaderboards, assign rewards and commissions, and the like.

In the illustrated example, the storage 815 includes a set of user profiles 865 (which may correspond to the user profiles 135 of FIG. 1). Although depicted as residing in storage 815, the depicted data may be stored in any suitable location. Similarly, although not depicted in the illustrated example, the storage 815 may also include additional data, such as data relating to specific available items (e.g., the item data 140 of FIG. 1).

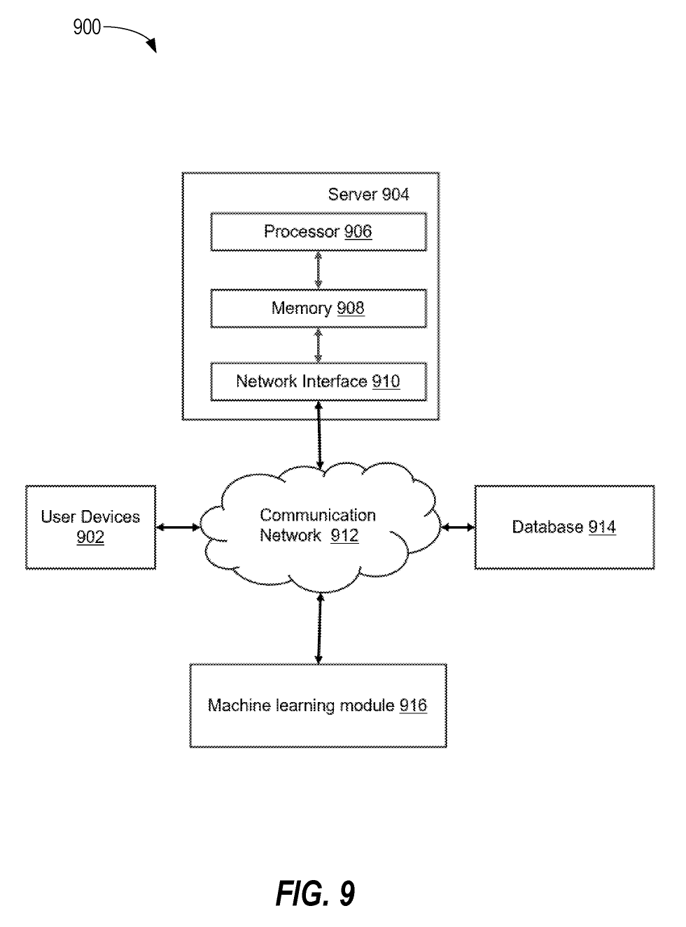

FIG. 9 is a diagram illustrating various exemplary components of a system 900 for managing and categorizing user-generated inventory lists across multiple digital platforms, in accordance with some embodiments of the present disclosure. In some embodiments, the system 900 corresponds to and provides additional or alternative detail for the system 100 of FIG. 1. With reference to FIG. 9, the system 900 includes a user device 902 (which may correspond to the client system 105 of FIG. 1), a server 904 (which may correspond to the interaction system 110 of FIG. 1), a processor 906, a memory 908, a network interface 910, a communication network 912, a database 914 (which may correspond to the user profiles 135 and/or item data 140 of FIG. 1), and a machine learning module 916 (which may correspond to the interaction system 110 of FIG. 1). These components work together to enable users to create, customize, and share inventory lists while leveraging machine learning algorithms to provide personalized recommendations and compile purchases from multiple online stores into a single, organized list.

In embodiments, the network interface 910 serves as the medium facilitating data transfer between the user device 902 and the server 904. The network interface 910 may support wired, wireless, or any combination of wired and wireless communication networks, such as cellular networks, Wi-Fi, the internet, local area networks (LANs), or the like. In one embodiment, the network interface 910 may include one or more networks such as a data network, a wireless network, a telephony network, or any combination thereof. The data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network. It may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In embodiments, the communication network 912 represents the infrastructure through which data is transmitted between the user device 902 and the server 904. The communication network 912 may include various types of networks, such as the internet, cellular networks, Wi-Fi, or local area networks (LANs), ensuring seamless and secure data exchange between the user device 902 and the server 904. The communication network 912 operates in conjunction with the network interface 910 to facilitate real-time communication and data transfer.

The user device 902 may include a range of devices, such as a smartphone, tablet, desktop computer, or laptop. These devices represent various types of user equipment that can access and interact with the system 900 via the network interface 910 and communication network 912. Each device may be configured to send and receive data across the network in a manner that ensures secure and reliable interaction with the system 900. A person of ordinary skill in the art will appreciate that the user device 902 may include, but is not limited to, intelligent, multi-sensing, network- connected devices that may integrate seamlessly with each other and/or with a central server or a cloud-computing system or any other device that is network-connected.

Additionally, in some embodiments, the user device 902 may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user device 902 may include, but is not limited to, any electrical, electronic, electromechanical, or equipment, or a combination of one or more of the above devices, such as virtual reality (VR) devices, augmented reality (AR) devices, laptop, a general-purpose computer, desktop, personal digital assistant, tablet computer, mainframe computer, or any other computing device, wherein the user device 902 may include one or more in-built or externally coupled accessories including, but not limited to, a visual aid device such as a camera, an audio aid, a microphone, a keyboard, and input devices for receiving input from the user or the entity such as a touchpad, touch-enabled screen, electronic pen, and the like. A person of ordinary skill in the art will appreciate that the user device 902 may not be restricted to the mentioned devices, and various other devices may be used.

The server 904 is responsible for managing and processing user data, inventory lists, and purchase history. The server 904 is communicatively coupled to the processor 906 and the memory 908, which together form the core processing unit of the system 900. The processor 906 is responsible for executing instructions stored in the memory 908, which include modules for creating user profiles, receiving user input, generating personalized recommendations, enabling sharing via shareable links or QR codes, and compiling purchases from multiple online stores. The memory 908 stores processor-executable instructions, which, when executed by the processor 906, enable the system 900 to manage and categorize user-generated inventory lists across multiple digital platforms. The database 914 is hosted by the server 904 and is configured to store at least a first user account associated with a first user. The database 914 stores user profiles, user-generated inventory lists, and purchase history, ensuring that all data is securely stored and easily accessible for processing.

In some embodiments, the machine learning module 916 is responsible for generating personalized recommendations based on user activity, preferences, and historical data. The machine learning module 916 analyzes patterns in user behavior to suggest items that align with the user’s interests. The machine learning algorithms are trained using a combination of supervised and unsupervised learning techniques on a dataset comprising user activity, preferences, and historical data. The machine learning module 916 is enriched with non-sensitive metadata about the user’s preferences and shopping habits to generate personalized recommendations without compromising user privacy.

The network interface 910 enables real-time communication between the user device 902 and the server 904, supporting a range of activities and data transactions. In some embodiments, the network interface 910 may represent various network types, including, but not limited to, wireless networks, the internet, cellular networks, or local area networks, providing flexible and dynamic connectivity for user devices. The network interface 910 ensures that data transmitted between the user device 902 and the server 904 is secure, encrypted, and compliant with organizational security policies.

In some embodiments, the inclusion of the user device 902 offers users the flexibility to access and control the system 900 through diverse devices. This flexibility allows users to interact with the system 900 through a range of device interfaces, facilitating accessibility and convenience. The system 900, through the user interface and display components of the user device 902, may provide feedback and data to the user, enabling a responsive and user-centric interaction model. The user interface is designed to be intuitive and user-friendly, allowing non-technical users to leverage the capabilities of the system 900 without requiring extensive technical expertise.

In some embodiments, the system 900 enhances user accessibility to advanced inventory management functionalities and personalized shopping experiences via a centralized communication structure, which securely channels data to and from various types of the user device 902 through the network interface 910 and communication network 912. The seamless integration of these components allows the system 900 to support a range of operational scenarios for users, improving access and control over system functionalities while ensuring the protection of user data. The system 900 is designed to operate across multiple digital platforms, ensuring that users can manage and categorize their inventory lists efficiently while leveraging the power of machine learning algorithms for personalized recommendations and enhanced shopping experiences.

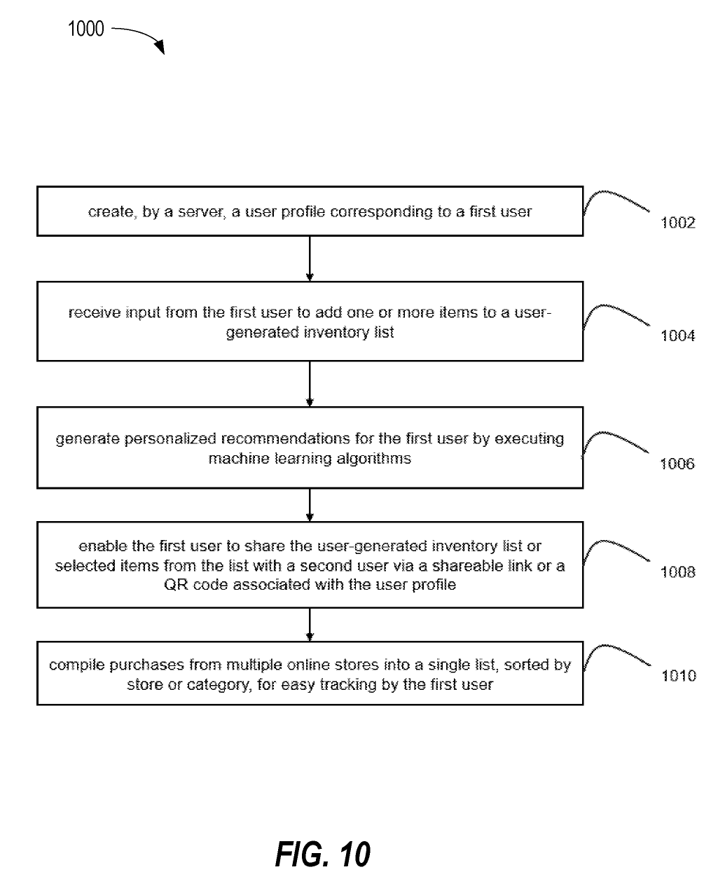

FIG. 10 illustrates an exemplary flow chart depicting a method 1000 for managing and categorizing user-generated inventory lists across multiple digital platforms, in accordance with an embodiment of the present disclosure. It will be understood that each block of the flow diagram of the method 1000 may be implemented by various means, such as hardware, firmware, processors, circuitry, and/or other communication devices associated with executing software, including one or more computer program instructions. For example, computer program instructions may embody the procedures described in this method. In this regard, the computer program instructions that embody the procedures described above may be stored in the memory of a computing device, employing an embodiment of the present disclosure, and executed by a processor.

These computer program instructions may be stored in a computer-readable memory, which may direct a computer or other programmable apparatus to function in a specified manner. By doing so, the instructions stored in the computer-readable memory produce an article of manufacture, the execution of which implements the function specified in the flowchart blocks. The instructions may also be loaded onto a computer or programmable apparatus to initiate a series of operations on the device. This results in a computer-implemented process in which the instructions executing on the apparatus provide operations that implement the functions specified in the flow diagram blocks.

Accordingly, the blocks of the flow diagram support combinations of means for performing the specified functions and combinations of operations for performing these functions. It will also be understood that one or more blocks of the flow diagram, and combinations of blocks within it, may be implemented by special-purpose hardware-based computer systems or a combination of special-purpose hardware and computer instructions.

FIG. 10 is explained in conjunction with elements from FIG. 9. At step 1002, the method 1000 is initiated. The method 1000, at step 1002, may include creating, by the server 904, a user profile corresponding to a first user, wherein the user profile is registered with the server 904. The user profile may include personal information, preferences, and a unique identifier, allowing users to access and manage their inventory lists. The user interface may serve as the primary point of interaction between the user and the system 900, allowing the user to create and customize their profile, upload personal pictures, and choose background images to personalize their profile. The user profile may also include options for the user to make their profile public or private, depending on their preferences.

At step 1004, the method 1000 may include receiving, by the server 904, input from the first user to add one or more items to a user-generated inventory list, wherein the one or more items are categorized based on user preferences. The user may add items from various categories such as clothes & accessories, electronics, home & garden, beauty, sports, books, media, office supplies, construction, travel, luxury goods, subscription services, digital products, wine, spirits, healthcare, or items specific to an online store (e.g., Amazon, Whole Foods, Total Wine & More, Macy’s, Home Depot, IKEA, etc.). The inventory list may be organized by category or store, and the user may customize the appearance of the list to resemble a closet, wine cellar, shopping list, locker, bookcases, or other creative formats. The user may also input the best place to purchase each item, ensuring the list is organized and practical.

At step 1006, the method 1000 may include generating, by the server 904, personalized recommendations for the first user by executing machine learning algorithms, wherein the machine learning algorithms analyze user activity, preferences, and historical data. The machine learning algorithms may be trained using a combination of supervised and unsupervised learning techniques on a dataset comprising user activity, preferences, and historical data. The algorithms may analyze patterns in user behavior to suggest items that align with the user’s interests. For example, if users frequently add wine-related items to their inventory list, the system 900 may recommend new wines, accessories, or wine-related experiences. The machine learning module 916 may also provide ratings, reviews, prices, details of the recommended items, alternatives, and comparisons.

At step 1008, the method 1000 may include enabling, by the server 904, the first user to share the user-generated inventory list or selected items from the list with a second user via a shareable link or a QR code associated with the user profile. The shareable link or QR code may provide access to the user’s inventory list or selected items, allowing the second user to view, comment, or purchase the items. The user may share their profile or inventory list on all social media platforms, over text, and email, making it easy to share recommendations with friends, family, or followers. The system 900 may also allow users to generate themed lists, such as a holiday gift guide or a home renovation checklist, which can be shared with others.

At step 1010, the method 1000 may include compiling, by the server 904, purchases from multiple online stores into a single list, sorted by store or category, for easy tracking by the first user. The system 900 may compile all online shopping lists into one destination, categorizing items by store or category for easy monitoring. For example, if a user purchases items from Amazon, Whole Foods, and Home Depot, the system 900 may compile these purchases into a single list, sorted by store or category. This feature allows users to track their purchases easily, view their shopping history, and manage their inventory lists in one place.

Method 1000 may conclude after step 1010, ensuring that the user’s inventory list has been created, customized, and shared and that purchases have been compiled into a single list for easy tracking. Method 1000 may provide a scalable and user-friendly framework for managing and categorizing user-generated inventory lists across multiple digital platforms, allowing users to organize their favorite items, receive personalized recommendations, and share their lists with others.

For the sake of explanation, consider an exemplary scenario where a user creates a profile on the platform and adds items to their inventory list, such as a new pair of running shoes from Nike, a bottle of wine from Total Wine & More, and a set of kitchen utensils from IKEA. The user customizes the appearance of their inventory list to resemble a closet, making it visually appealing and easy to navigate. The system 900 analyzes the user’s activity and preferences and generates personalized recommendations, such as a new running watch from Garmin, a wine decanter, and a set of IKEA storage containers. The user shares their inventory list with a friend via a shareable link, and the friend purchases the running shoes from Nike using the link. The system 900 compiles the user’s purchases from Nike, Total Wine & More, and IKEA into a single list, sorted by store, for easy tracking.

By implementing method 1000, users may ensure that their inventory lists are organized, personalized, and easily shareable, while also receiving commission for purchases made through their shared links. Method 200 may provide a scalable, user-friendly inventory management approach, supporting individual and collaborative use cases across multiple digital platforms. This setup may enhance the user experience, encourage social sharing, and enable users to fully utilize the platform's capabilities without compromising their privacy or security.

In some embodiments, the system 900 of FIG. 9 and/or the method 1000 of FIG. 10 may be implemented using the computing device 800 of FIG. 8. For example, the computing device e800 may execute instructions stored in memory to perform the steps of the method described in FIG. 10, including creating user profiles, receiving user input to add items to inventory lists, generating personalized recommendations, enabling sharing via shareable links or QR codes, and compiling purchases from multiple online stores. The computing device 800 may further facilitate secure communication between the server and user devices, ensuring user data is protected during transmission, as well as allowing users to interact with the system, submit requests, and receive responses. The computing device 800 may further securely store user profiles, inventory lists, and purchase history within the system.

In this way, users may ensure that their inventory lists are organized, personalized, and easily shareable while also receiving commission for purchases made through their shared links. The described embodiments may provide a scalable, user-friendly inventory management approach, supporting individual and collaborative use cases across multiple digital platforms. This setup may enhance the user experience, encourage social sharing, and enable users to fully utilize the platform's capabilities without compromising their privacy or security.

Using embodiments of the present disclosure, organizations may ensure that the sensitive data is processed securely while leveraging the power of Large Language Models (LLMs) for advanced analytics and automation. The describe environments may provide a scalable, secure data processing approach that supports individual and bulk operations across multiple user requests. This setup may enhance data security, ensure compliance with regulatory requirements, and enable organizations to fully utilize the capabilities of AI-driven tools without compromising sensitive information.

In some embodiments of the present disclosure, a system for managing and categorizing user-generated inventory lists across multiple digital platforms is provided, the system comprising: a server including at least one processor, a non-transitory computer-readable medium storing a computer-executable program code, and a network interface configured to operatively connect the server with a plurality of remote user devices. The system may further include a database hosted by the server, the database configured to store at least a first user account associated with a first user, wherein, when the computer-executable program code is executed by the at least one processor, the at least one processor is configured to perform operations.

The operations may include creating a user profile corresponding to the first user, wherein the user profile is registered with the server, receiving input from the first user to add one or more items to a user-generated inventory list, wherein the one or more items are categorized based on user preferences, generating personalized recommendations for the first user by executing machine learning algorithms, wherein the machine learning algorithms analyze user activity, preferences, and historical data, enabling the first user to share the user-generated inventory list or selected items from the user-generated inventory list with a second user via a shareable link or a QR code associated with the user profile, and compiling purchases from multiple online stores into a single list, sorted by store or category, for easy tracking by the first user.

In some cases, the at least one processor is further configured to allow the first user to customize the appearance of the user-generated inventory list to resemble a closet, wine cellar, shopping list, locker, or bookcase; provide sales incentives based on user activity and purchases, including discounts, reward points, and gifting options.

In some cases, the at least one processor is further configured to enable the first user to permit brands associated with items on the user-generated inventory list to send marketing ideas or promotional offers; allow brand competitors to share their products' pros and cons with the first user.

In some embodiments, a computer-implemented method for managing and categorizing user-generated inventory lists across multiple digital platforms is provided. The method includes creating, by a server, a user profile corresponding to a first user, wherein the user profile is registered with the server, receiving, by the server, input from the first user to add one or more items to a user-generated inventory list, wherein the one or more items are categorized based on user preferences, generating, by the server, personalized recommendations for the first user by executing machine learning algorithms, wherein the machine learning algorithms analyze user activity, preferences, and historical data, enabling, by the server, the first user to share the user-generated inventory list or selected items from the list with a second user via a shareable link or a QR code associated with the user profile, and compiling, by the server, purchases from multiple online stores into a single list, sorted by store or category, for easy tracking by the first user.

In some embodiments, the method further includes allowing the first user to customize the appearance of the user-generated inventory list to resemble a closet, wine cellar, shopping list, locker, or bookcase, and providing sales incentives, including discounts, reward points, and gifting options, based on user activity and purchases.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
accessing a user profile of a first user of an interactive platform;
generating, based on the user profile, a personalized artificial intelligence (AI) assistant;
generating a plurality of category recommendations, for a plurality of categories, based on the user profile and using the personalized AI assistant;
generating a plurality of virtual rooms for the plurality of category recommendations, wherein each respective virtual room of the plurality of virtual rooms corresponds to a respective category of the plurality of categories and comprises a respective set of category recommendations from the plurality of category recommendations; and
outputting, for the first user, a first set of category recommendations of the plurality of category recommendations in a first virtual room of the plurality of virtual rooms.

2. The method of claim 1, wherein generating the plurality of virtual rooms comprises, for each respective category of the plurality of categories, customizing at least one of (i) an appearance, (ii) speech, or (iii) a personality of the personalized AI assistant based on the respective category.

3. The method of claim 1, wherein outputting the first set of category recommendations comprises customizing at least one of (i) an appearance, (ii) speech, or (iii) a personality of the personalized AI assistant based on a first item of the first set of category recommendations.

4. The method of claim 1, wherein generating the plurality of virtual rooms comprises, for each respective virtual room of the plurality of virtual rooms:
identifying a respective authority user for a respective category, of the plurality of categories, corresponding to the respective virtual room; and
adding an avatar corresponding to the respective authority user to the respective virtual room.

5. The method of claim 1, wherein generating the personalized AI assistant comprises:
training a recommendation machine learning model based on the user profile; and
generating an avatar to represent the personalized AI assistant based on a personality selected by the first user.

6. The method of claim 1, wherein generating the plurality of category recommendations comprises processing, using the personalized AI assistant, at least one of:
(i) previous purchases of the first user,
(ii) a calendar of events for the first user,
(iii) a budget of the first user, or
(iv) preferences of the user.

7. The method of claim 1, further comprising:
accessing a list of items selected by the first user; and
generating a first profile virtual room for the first user comprising the list of items.

8. The method of claim 7, further comprising:
generating a link to the first profile virtual room for the first user;
receiving, from a second user, a request via the link; and
outputting, for the second user, the list of items in the first profile virtual room, wherein the first profile virtual room comprises an avatar of the first user.

9. The method of claim 8, further comprising:
receiving, from the second user, selection of a first item of the list of items;
updating one or more leaderboards based on the selection; and
providing, to the first user, a commission based on the selection.

10. The method of claim 1, wherein outputting the first set of category recommendations in the first virtual room comprises outputting the first virtual room a virtual reality space, wherein items of the first set of category recommendations are output as virtual items in the virtual reality space.

11. One or more non-transitory computer readable media containing, in any combination, computer program code that, when executed by operation of any combination of one or more processors, performs an operation comprising:
accessing a user profile of a first user of an interactive platform;
generating, based on the user profile, a personalized artificial intelligence (AI) assistant;
generating a plurality of category recommendations, for a plurality of categories, based on the user profile and using the personalized AI assistant;
generating a plurality of virtual rooms for the plurality of category recommendations, wherein each respective virtual room of the plurality of virtual rooms corresponds to a respective category of the plurality of categories and comprises a respective set of category recommendations from the plurality of category recommendations; and
outputting, for the first user, a first set of category recommendations of the plurality of category recommendations in a first virtual room of the plurality of virtual rooms.

12. The one or more non-transitory computer readable media of claim 11, wherein generating the plurality of virtual rooms comprises, for each respective category of the plurality of categories, customizing at least one of (i) an appearance, (ii) speech, or (iii) a personality of the personalized AI assistant based on the respective category.

13. The one or more non-transitory computer readable media of claim 11, wherein outputting the first set of category recommendations comprises customizing at least one of (i) an appearance, (ii) speech, or (iii) a personality of the personalized AI assistant based on a first item of the first set of category recommendations.

14. The one or more non-transitory computer readable media of claim 11, wherein generating the plurality of virtual rooms comprises, for each respective virtual room of the plurality of virtual rooms:
identifying a respective authority user for a respective category, of the plurality of categories, corresponding to the respective virtual room; and
adding an avatar corresponding to the respective authority user to the respective virtual room.

15. The one or more non-transitory computer readable media of claim 11, wherein generating the personalized AI assistant comprises:
training a recommendation machine learning model based on the user profile; and
generating an avatar to represent the personalized AI assistant based on a personality selected by the first user.

16. A system, comprising:
one or more processors; and
one or more memories storing a program, which, when executed on any combination of the one or more processors, performs operations, the operations comprising:
accessing a user profile of a first user of an interactive platform;
generating, based on the user profile, a personalized artificial intelligence (AI) assistant;
generating a plurality of category recommendations, for a plurality of categories, based on the user profile and using the personalized AI assistant;
generating a plurality of virtual rooms for the plurality of category recommendations, wherein each respective virtual room of the plurality of virtual rooms corresponds to a respective category of the plurality of categories and comprises a respective set of category recommendations from the plurality of category recommendations; and
outputting, for the first user, a first set of category recommendations of the plurality of category recommendations in a first virtual room of the plurality of virtual rooms.

17. The system of claim 16, wherein generating the plurality of virtual rooms comprises, for each respective category of the plurality of categories, customizing at least one of (i) an appearance, (ii) speech, or (iii) a personality of the personalized AI assistant based on the respective category.

18. The system of claim 16, wherein outputting the first set of category recommendations comprises customizing at least one of (i) an appearance, (ii) speech, or (iii) a personality of the personalized AI assistant based on a first item of the first set of category recommendations.

19. The system of claim 16, wherein generating the plurality of virtual rooms comprises, for each respective virtual room of the plurality of virtual rooms:
identifying a respective authority user for a respective category, of the plurality of categories, corresponding to the respective virtual room; and
adding an avatar corresponding to the respective authority user to the respective virtual room.

20. The system of claim 16, wherein generating the personalized AI assistant comprises:
training a recommendation machine learning model based on the user profile; and
generating an avatar to represent the personalized AI assistant based on a personality selected by the first user.
